(19) United States
(12) Patent Application Publication
(10) Pub. No.: US 2004/0226777 A1
(43) Pub. Date: Nov. 18, 2004

(54) Floor number display at landing and in car, informative to elevator passengers

(76) Inventors: Markku Kakko, Hyvinkaa (FI); Pentti Laihanen, Hyvinkaa (FI); Johannes De Jong, Jarvenpaa (FI); Rauno Hatakka, Riihimaki (FI)

Correspondence Address: BIRCH STEWART KOLASCH & BIRCH, PO BOX 747, FALLS CHURCH, VA, 22040-0747, US

(21) Appl. No.: 10/756,379

(22) Filed: Jan. 14, 2004

Related U.S. Application Data
(63) Continuation of application No. PCT/FI02/00661, filed on Aug. 12, 2002.

(30) Foreign Application Priority Data
Aug. 14, 2001 (FI) FI20011637

(51) Int. Cl. B66B 1/34; B66B 3/00

(52) U.S. Cl. 187/391

(57) ABSTRACT

The present invention concerns a floor number display (1, 2) informative to the elevator passenger at landing and in car when the passenger issues destination calls to the elevator.

The present invention relates to a floor number display at landing and in car, informative to the passenger, as defined in the preamble of claim 1.

A common problem with floor number display solutions showing destination calls is that, at the starting floor and in the car, the elevator passenger cannot obtain from the floor number displays sufficiently informative information regarding destination calls entered. This may lead to a situation where an elevator passenger cannot decide when to leave the car and therefore rides past his/her destination floor. On the other hand, he/she may also choose the wrong elevator already at the starting floor.

The object of the invention is to eliminate the drawbacks encountered in prior-art solutions referred to above.

According to the invention, via the floor number display informative to the passenger, the destination floors are displayed to the elevator passenger at the passenger's starting floor and in the car in different ways as compared with each other, when the elevator passenger issues destination calls to the elevator.

In more precise terms, the floor number display at landing and in car informative to the passenger according to the invention is characterized by what is presented in the characterization part of claim 1. The features characteristic of certain preferred embodiments of the invention are presented in the subclaims.

The floor number display of the invention, which is as informative as possible to the elevator passenger both at the landing and in the car, provides significant advantages as compared with prior art.

In a preferable case, the floor number display according to the present the invention shows fewer calls to be displayed. Therefore, the elevator passenger can more readily distinguish his/her own destination floor among the other calls shown on the floor number display. The floor number display of the invention serves as expediently as possible both elevator passengers waiting for an elevator in an elevator lobby and elevator passengers already in an elevator car.

In the following, the invention will be described in detail with reference to the attached drawings, wherein

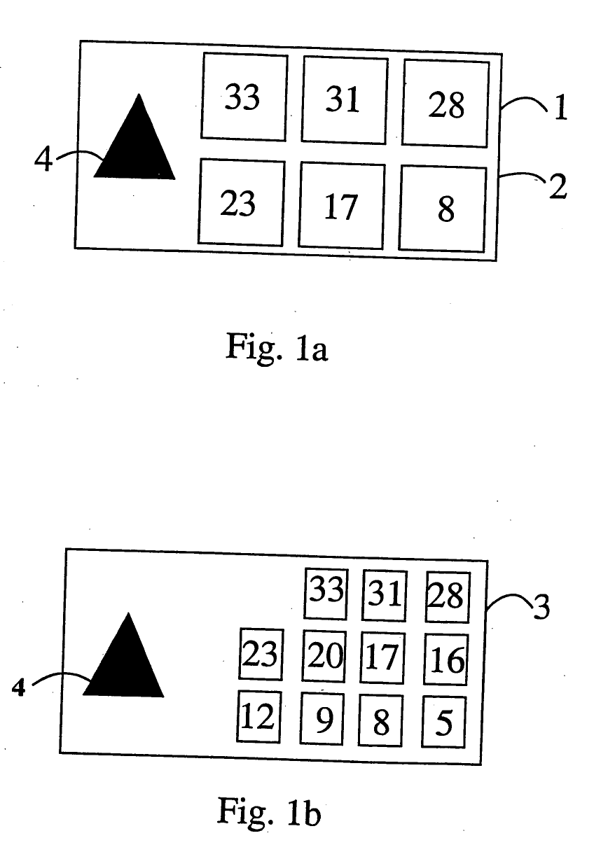

FIG. 1a presents a floor number display according to the invention, located at the starting floor of an elevator passenger,

FIG. 1b presents a floor number display according to the invention placed in an elevator car,

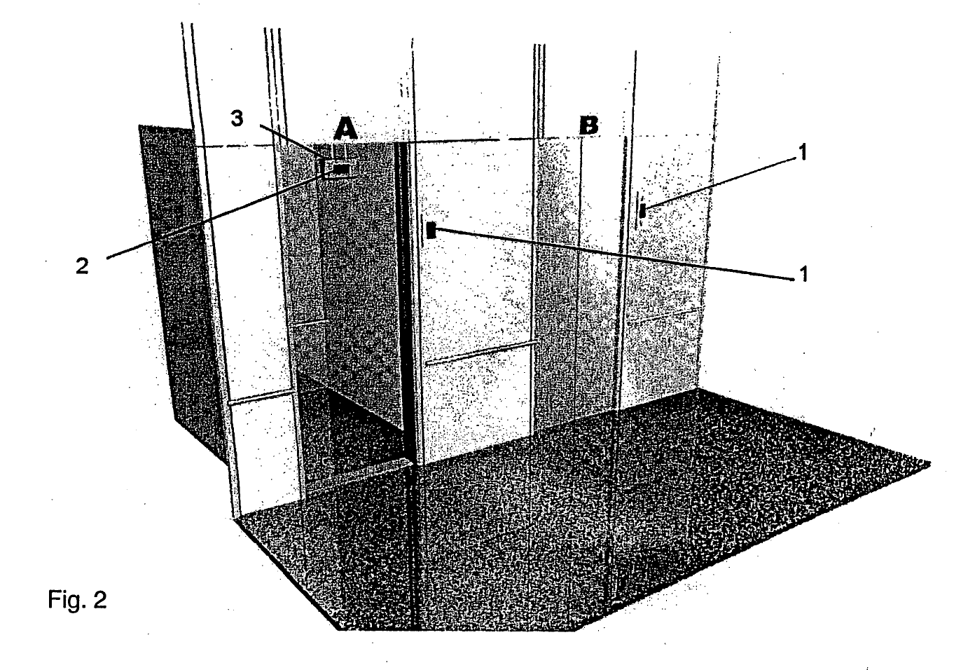

FIG. 2 shows how the floor number displays of the invention are disposed in the elevator lobby and in the car.

The invention concerns a floor number display 1, 2 informative to the elevator passenger at the landing and in the car when the passenger issues destination calls to the elevator. According to the most preferred embodiment of the invention, on the aforesaid floor number displays 1, 2, 3, destination floors are shown in different ways at the elevator passenger's starting floor and in the car as compared with each other.

FIG. 1a presents a floor number display 1 according to the invention, placed at the elevator passenger's starting floor. According to an embodiment of the present invention, the aforesaid floor number display 1 at the elevator passenger's starting floor displays destination calls issued from the aforesaid floor and allocated to the aforesaid elevator from the aforesaid floor onward. The floor number display 1, which is placed in the elevator lobby, also comprises an arrow 4 indicating traveling direction.

FIG. 1b presents a floor number display 2, 3 according to the invention in an elevator car. Via the floor number display 2 of the invention in the car, while the elevator door is open, passengers standing at the landing outside the elevator car and intending to enter the car are shown the same information as via the aforesaid floor number display 1 at the elevator passenger's starting floor.

According to the present invention, via the aforesaid floor number display 3 in the car, the destination calls allocated to the aforesaid elevator are displayed to the elevator passengers in the car. In other words, the aforesaid floor number display 3 in the car is used to show the stops needed to admit passengers as well as the stops associated with the destination floor. On the aforesaid floor number display 3, all destination floors allocated to the car in question are displayed in the order of stops. Thus, the elevator passenger can easily and clearly discern which destination floor will be the next one and when the elevator will reach the passenger's own destination floor.

In addition, the floor number displays 2, 3 placed in the car also comprise an arrow indicating the traveling direction.

According to the invention, the floor number display 3 placed in the elevator car and showing the destination floor to the elevator passengers changes the information shown on the display according to the floor for each stop separately. Thus, after each stop, this aforesaid floor number display 2 placed in the car and permitting the floor numbers to be seen from the lobby updates the destination floors shown on the display. In other words, the aforesaid floor number display 2 placed in the car and permitting the floor numbers to be seen from the elevator lobby changes the floor number data displayed at each stopping floor according to what is displayed by the floor number display 1 in the elevator lobby on the stopping floor in question.

FIG. 2 illustrates the disposition of floor number displays 1, 2, 3 according to the invention in the elevator lobby and in the car. As shown in the figure, the floor number display 1 of the invention at the elevator passenger's starting floor is so disposed in the elevator lobby that the aforesaid floor number display 1 beside each elevator indicates the destination floors allocated to the elevator in question. The floor number displays 2, 3 placed inside the elevator car and displaying information to the passengers are disposed in the upper part of the elevator car. Moreover, the aforesaid floor number display 2, 3 placed inside the elevator car is a two-sided display such that, when the elevator door is open, it displays to passengers on the landing the same destination floor information as is displayed by the floor number display 1 placed in the elevator lobby on the elevator passenger's starting floor. Via floor number display 3, car call information is displayed toward the passengers inside the car as illustrated in FIG. 1b.

In the foregoing, the invention has been described by way of example by the aid of the attached drawings while different embodiments of the invention are possible within the scope of the inventive idea defined in the claims.

1. Floor number display (1, 2, 3) informative to the elevator passenger at landing and in car when the passenger issues destination calls to the elevator, characterized in that, via the aforesaid floor number displays (1, 2, 3), destination floors are displayed to the elevator passenger at the passenger's starting floor and in the car in different ways as compared with each other.

2. Floor number display according to claim 1, characterized in that the aforesaid floor number display (1) at the elevator passenger's starting floor displays destination calls issued from the aforesaid floor and allocated to the aforesaid elevator from the aforesaid floor onward.

3. Floor number display according to claim 1, characterized in that, via the aforesaid floor number display (2) in the car, while the elevator door is open, passengers standing at the landing outside the elevator car and intending to enter the car are shown the same information as via the aforesaid floor number display (1) at the elevator passenger's starting floor.

4. Floor number display according to claim 1, characterized in that, via the aforesaid floor number display (3) in the car, the destination calls allocated to the aforesaid elevator are displayed to the elevator passengers.

5. Floor number display according to claim 4, characterized in that via the aforesaid number display (3) in the car are displayed the stops needed to admit passengers and the stops associated with the destination floor.

6. Floor number display according to claim 3, characterized in that, after each stop, the aforesaid floor number display (2) placed in the car and permitting the floor numbers to be seen from the elevator lobby updates the destination floors shown on the display.

7. Floor number display according to claim 3, characterized in that the aforesaid floor number display (2, 3) placed inside the elevator car is a two-sided display.

8. Floor number display according to claim 1, characterized in that the aforesaid floor number displays (1, 2, 3) comprise an arrow (4) indicating the traveling direction.
